(19) United States
(12) Patent Application Publication
(10) Pub. No.: US 2026/0333531 A1
(43) Pub. Date: Oct. 22, 2026

(54) METHOD FOR ADJUSTING THE BRIGHTNESS OF LIGHT SOURCES AND SYSTEM FOR PROJECTING LIGHT BEAMS FOR THE ACTUATION OF SAID METHOD

(71) Applicant: MUSIC & LIGHTS S.R.L., Minturno (Latina) (IT)

(72) Inventors: Andrea GABRIELLI, Rimini (IT); Fabio SORABELLA, Formia (Latina) (IT)

(21) Appl. No.: 19/468,679

(22) Filed: Feb. 3, 2026

(30) Foreign Application Priority Data
Feb. 4, 2025 (IT) 102025000002013

(51) Int. Cl. H05B 45/10; H05B 45/20; H05B 45/325; H05B 47/155; H05B 47/175

(52) U.S. Cl. CPC H05B 45/10; H05B 45/20; H05B 45/325; H05B 47/155; H05B 47/196

(57) ABSTRACT

A method for adjusting the brightness of a first group of LED light sources having a first number of sources, includes: providing a control unit; providing a plurality of current adjustment modules, each associated with a respective light source and to one of the light sources to feed it with power supply current. The control unit turns on the light sources of the first group to emit light at a first brightness and controls the current adjustment modules with a first current; decreases the power supply current of at least a part of the current adjustment modules, down to a predetermined threshold current value corresponding to a second brightness level, lower than the first brightness, and then turns off a second group of light sources, having a second number of sources, the second group of light sources defined by a part of the light sources of the first group.

This application claims priority to Italian Patent Application 102025000002013 filed Feb. 4, 2025. The entirety of this application is incorporated by reference herein.

The present invention relates to a method for adjusting the brightness of light sources and a system for projecting light beams for the actuation of said method.

In the cinematographic sector there are various types of lighting systems, that is, devices for different applications on the production set: the so-called “soft light” devices and the so-called “hard light or long throw” devices.

The soft light projection devices are designed to diffuse a homogeneous and soft light over a large area.

These devices are often used to reduce hard shadows and create more even lighting on the scene.

Hard light projection devices are, on the other hand, designed to project a concentrated and directional beam of light over a significant distance.

These devices generate well defined shadows and a more intense and focused luminous effect.

Such devices are often used to simulate natural light sources such as the sun, or to highlight specific elements or characters inside a scene.

The light sources of such devices are, normally, controlled by a current generator module, that is to say, the generator module actuates the light sources with a predetermined current.

Such devices generally comprise LED light sources.

A problem often encountered in such types of devices is that of being able to guarantee a correct brightness emitted by the light sources even in the event of a decrease in the control current, for example in the face of low brightness settings and/or during the turning off procedure.

In fact, it has been found, experimentally, that when the light sources are fed with low control currents (whose value depends on the type of LEDs forming the source) there is a drift in the colour of the light emitted by the light source and/or an abrupt transition from a lighting condition to one of total absence of lighting.

Operating the LEDs in an unstable condition, which highlights in particular a drift of colour, is therefore a problem to be avoided.

These effects therefore cause an instability of the light sources, which makes the lighting device difficult to control in the event of low control currents.

The aim of the present invention is to provide a method of controlling light sources and a system for projecting light beams that overcome the drawbacks of the above-mentioned prior art.

In particular, the aim of the present invention is to provide a method for adjusting the brightness of light sources and a system for projecting light beams that allow an optimal lighting, from the point of view of brightness and/or colour, even in low light conditions.

Said aims are fully achieved by a method for adjusting the brightness of light sources and by a system for projecting light beams, which are characterised by the claims below.

The main features of the invention will become more apparent from the following detailed description of a preferred, non-limiting embodiment, illustrated purely by way of example in the accompanying drawings, in which:

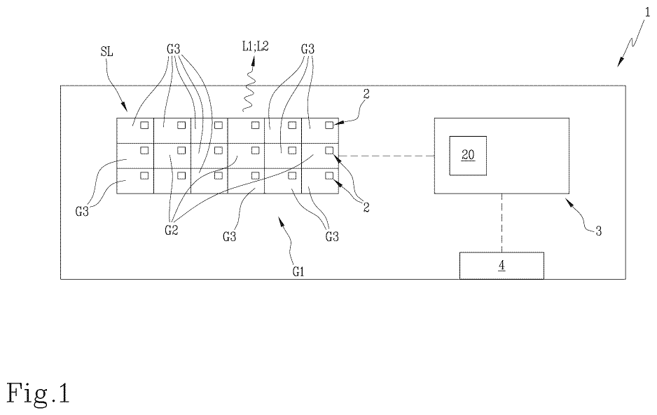

FIG. 1 schematically illustrates a system for projecting a light beam according to the present invention;

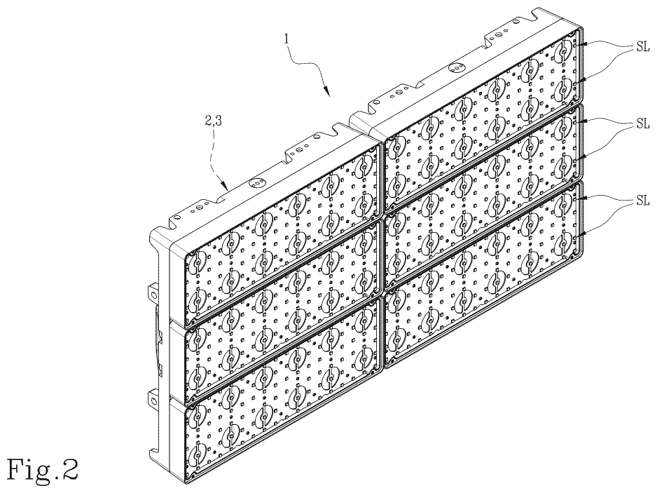

FIG. 2 illustrates the system for projecting light beam of FIG. 1, according to a preferred embodiment;

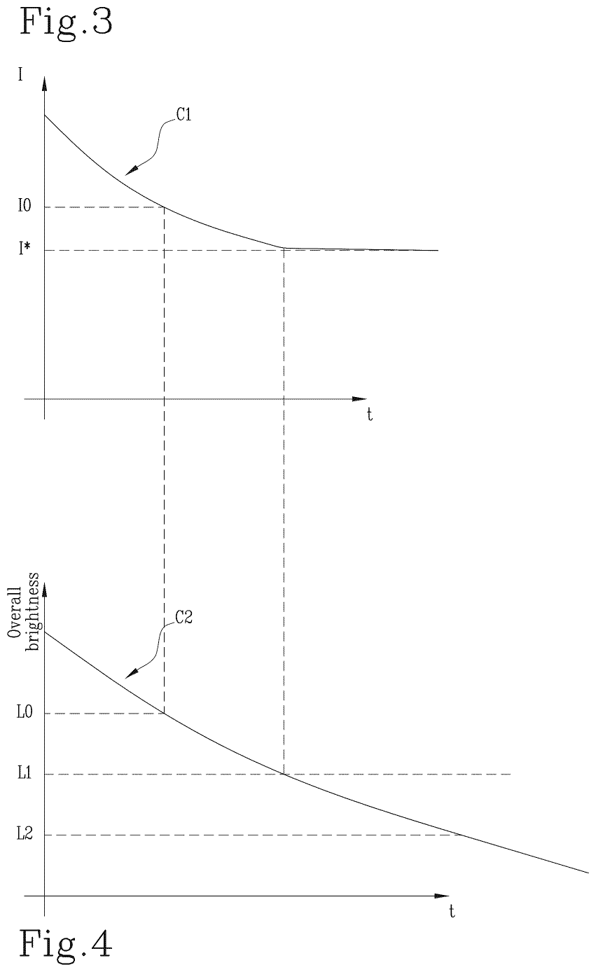

FIGS. 3 and 4 schematically illustrate some temporal relationships between the power supply current of some light sources and the brightness of the set of light sources, according to the present invention;

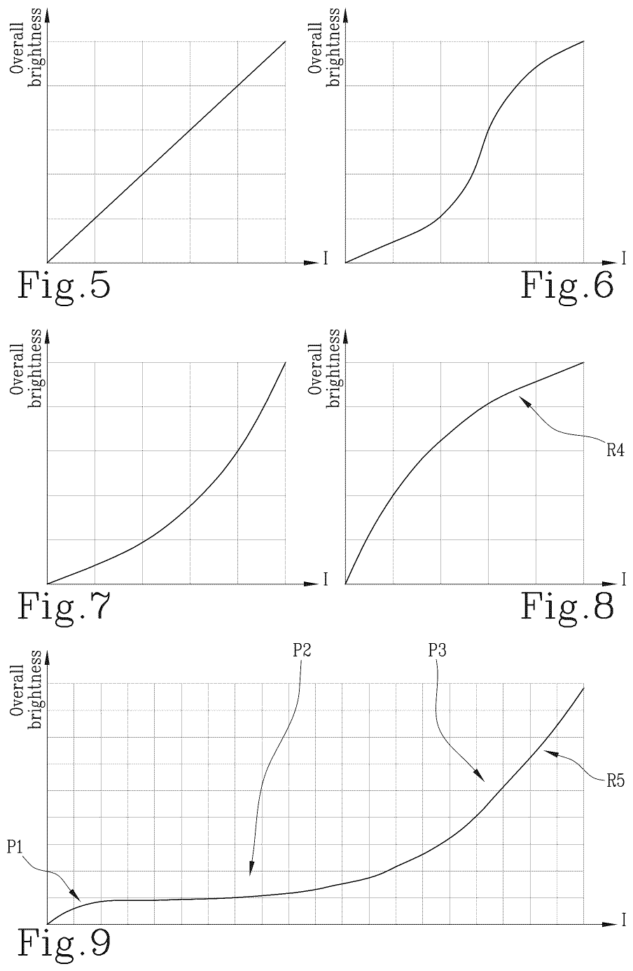

FIGS. 5 to 9 schematically illustrate some relationships between the overall brightness of the light sources and the power supply current of some sources, which can be used according to the method, that is, the system for projecting light beams according to the present invention.

The accompanying drawings illustrate a system for projecting light beams with the reference numeral 1.

The system 1 can be advantageously used in the entertainment sector, for example for applications on the production set.

The system 1 comprises:
a plurality of light sources SL of the LED type arranged to form a first group G1 of light sources SL;
a control unit 3;
a plurality of current adjustment modules 2, connected to said control unit 3, to be controlled, each of them being associated with a light source SL to supply it with current.

The control unit 3 is configured for:
turning on the light sources of the first group G1 to emit light according to a first brightness L0 and controlling the current adjustment modules 2 of the first group G1 for providing a first power supply current I0;
decreasing the power supply current of at least a part (preferably of each one) of said current adjustment modules 2 of the sources of the first group G1, down to a predetermined threshold current value I* (lower than the above-mentioned first power supply current I0), which corresponds to a predetermined second brightness level L1, lower than the first brightness L0, and carrying out the following steps:
turning off a second group G2 of light sources SL, having a second number n2 of sources, with said second group G2 of light sources SL defined by a part of the light sources SL of the first group G1
maintaining the remaining sources of the first group G1, defining a third group G3 of light sources SL having a third number n3 of sources and different from the second group G2, fed with a current preferably equal to (or, alternatively, higher than) the threshold current I*.

Note that the system 1 is preferably designed to obtain white light with varying colour temperature.

Preferably, the system 1 obtains the white light with variable colour temperature by means of a plurality of light sources SL, each composed of a plurality of LEDs of different colour (that is, different chromatic light emission).

According to one aspect, said steps of turning off a second group G2 of light sources SL and keeping the remaining sources of the first group G1 fed with a current equal to or higher (corresponding) to the threshold current I* allows light to be emitted according to a third level of brightness L2 different (according to an embodiment, lower) than the second level of brightness L1.

In essence, the above-mentioned steps comprise turning off a certain number of light sources SL (those forming the second group G2) in the face of a power supply current fed to the remaining sources of the first group G1, defining a third group G3 of light sources SL having a third number n3 of sources, substantially equal to the threshold current I*.

In short, and in other words, once all the light sources SL of the first group G1 have been brought to the power supply current equal to or greater than (corresponding to) the threshold current I*, some light sources SL (which form the second group G2) are (selectively) turned off: in this way, due to the turning off of some light sources, the overall brightness emitted by the projector 1 is decreased, without however bringing the remaining active sources to a level of power supply current lower than the threshold current I* (thus avoiding operation of the active light source SL in an area with greater instability, from the chromatic and/or light output point of view).

This advantageously means that the light sources SL kept turned on by the control unit 3 are each fed with an amount of current optimal for their operation.

In short, in this way, a gradual reduction in the brightness emitted by the light sources SL of system 1 is determined, without the occurrence of abrupt transitions between the light emission and the total absence of emitted lights.

Furthermore, advantageously, according to the invention, the light sources SL kept turned on are powered (individually) by a current (equal to or greater than the predetermined threshold value I*) which is sufficient to maintain a correct light emission (both at the intensity and chromatic level).

In essence, the idea behind the invention, in the event that the brightness is to be decreased, in particular by bringing it to extremely low levels (in the order of between 1 and 15% of the maximum brightness) is to decrease the overall power supply current of all the light sources down to a certain threshold value I* and, subsequently, turn off some of the light sources SL keeping those that remain active powered at a current equal to or greater than that of the threshold I*.

This is possible because the control unit 3 is configured to be able to individually turn on/off the light sources SL.

Further, the control unit 3 is configured to individually adjust each current adjustment module 2.

According to one aspect, each current adjustment module 2 is configured for adjusting a power supply current of each light source SL.

According to one aspect, the control unit 3 is configured for controlling the current adjustment module 2 and adjusting, individually, the power supply current of each light source SL.

According to another aspect, the control unit 3 is configured for controlling the current adjustment module 2 and adjusting the power supply current of each light source SL by means of PWM techniques.

According to another aspect, the lighting system 1 comprises:
a user interface 4, connected to the control unit 3 and configured for:
receiving data concerning a desired level of lighting (that is, light emission) of said light sources SL;
providing a display of settings of said lighting level.

Note that such user interface 4 may comprise a display and/or one or more commands.

These commands can be physical commands (buttons, selectors, switches, etc.) or virtual (that is, touch or voice commands).

According to another aspect, the user interface 4 comprises a connection module (physical connector and/or wireless network connection module) with a remote control device.

According to yet another aspect, the user interface 4 is configured to allow a dimming curve to be selected.

According to another aspect, the user interface 4 is configured to allow selection of a dimming curve (R1, R2, R3, R4, R5) that expresses a relation between the brightness emitted by each source and the power supply current of the single source at least between:
a linear relation R1 (FIG. 5);
an S-type relation, FIG. 6;
an exponential relation R3 (FIG. 7);
a reverse exponential relation R4 (FIG. 8);
a relation R5 having a first slope P1, with low power supply currents, a second intermediate slope P2, with intermediate power supply currents, and a third slope P3 for high power supply currents (FIG. 9).

According to the invention, the system for projecting light beams 1 further comprises a voltage generator module 20, controlled by the control unit 3.

It should be noted that the voltage generator module 20 provides a predetermined voltage to the individual current adjustment modules 2.

Preferably, according to one aspect, the voltage generator module 20 is configured to provide an adjustable voltage.

According to one aspect, at least said first group G1 of light sources SL comprises arrays of LEDs each composed of a plurality of light sources SL configured to emit light of different colours.

According to this aspect, the control unit 3 is configured for:
setting, depending on a set lighting colour, power supply current values associated with each illumination source SL of an array of LEDs;
feeding each light source SL with the respective set power supply current value;
controlling each current adjustment module 2 and adjusting, individually, the power supply current of each light source SL, to the respective set power supply current value.

According to a first embodiment, the control unit 3 is configured to simultaneously perform the following operations:
decreasing the power supply current of at least a part of said current adjustment modules 2 of the sources of the first group G1 (preferably of the sources of the third group G3);
turning off a second group G2 of light sources SL, having a second number n2 of sources, with said second group G2 of light sources SL defined by a part of the light sources SL of the first group G1.

According to this aspect, advantageously the decrease in brightness occurs due to the combined effect of the turning off of the light sources SL of the second group G2 and the decrease in current (linked to the brightness) of the light sources SL of the remaining sources of the first group G1 (defining the third group G3).

In accordance with a second embodiment, the control unit 3 is configured for turning off a second group G2 of light sources SL, having a second number n2 of sources, with said second group G2 of light sources SL defined by a part of the light sources SL of the first group G1, before decreasing the power supply current of at least a part of said current adjustment modules 2 of the sources of the first group G1.

According to this aspect, advantageously the decrease in brightness occurs first by turning off the light sources SL of the second group G2, and subsequently by decreasing the current (linked to the brightness) of the light sources SL of the remaining sources of the first group G1 (defining the third group G3).

In accordance with a third embodiment forming part of the invention, the control unit 3 is configured to turn off a second group G2 of light sources SL, having a second number n2 of sources, with said second group G2 of light sources SL defined by a part of the light sources SL of the first group G1, after having decreased the power supply current of at least a part of said current adjustment modules 2 of the sources of the first group G1.

According to this aspect, advantageously, the decrease in brightness occurs first by decreasing the current (linked to the brightness) of the light sources SL of the remaining sources of the first group G1 (defining the third group G3) and, subsequently, by turning off the light sources SL of the second group G2.

According to this aspect, the third brightness level I2 is lower than the second brightness level I1.

The invention also defines a method for adjusting the brightness of a plurality of light sources SL of the LED type, advantageously which can be operated by the system 1.

The method for adjusting the brightness of a plurality of light sources SL of the LED type arranged to form a first group G1 of light sources SL, comprises the following steps:
providing a control unit 3;
providing a plurality of current adjustment modules 2, each associated with a respective light source SL and connected to said control unit 3, to be controlled, and to one of said light sources SL to feed it with current by means of a power supply current.

The method also includes the following steps, carried out by the control unit 3:
turning on the light sources of the first group G1 to emit light at a first overall brightness L0 and controlling the current adjustment modules 2 of the first group G1 with a first current I0;
decreasing the power supply current of at least a part (preferably of each) of said current adjustment modules 2 of the sources of the first group G1, down to a predetermined threshold current value I*, which corresponds to a second predetermined overall brightness level L1, lower than the first overall brightness L0, and consequently carrying out the following steps:
turning off a second group G2 of light sources SL, having a second number n2 of sources, with said second group G2 of light sources SL defined by a part of the light sources SL of the first group G1;
continuing to feed the remaining sources of the first group G1, defining a third group G3 of light sources SL having a third number n3 of sources and different from the second group G2, fed with a current equal to or greater than the threshold current I*.

According to the method, said steps of turning off a second group G2 of light sources SL and keeping the remaining sources of the first group G1 fed with a current equal to or higher (corresponding) to the threshold current I* allows light to be emitted according to a third overall level of brightness L2 different (according to an embodiment, lower) than the second overall level of brightness L1.

According to a first embodiment, the following are performed simultaneously:
the step of decreasing the power supply current of at least a part of said current adjustment modules 2 of the sources of the first group G1
and the step of turning off a second group G2 of light sources SL, having a second number n2 of sources, with said second group G2 of light sources SL defined by a part of the light sources of the first group G1.

In accordance with a second embodiment, the step of turning off a second group G2 of light sources SL, having a second number n2 of sources, with said second group G2 of light sources SL defined by a part of the light sources SL of the first group G1, is carried out before the step of decreasing the power supply current of at least a part of said current adjustment modules 2 of the sources of the first group G1.

In accordance with a third embodiment, the steps of turning off a second group G2 of light sources SL and keeping the remaining sources of the first group G1, defining a third group G3 of light sources SL having a third number n3 of sources and different from the second group G2, fed with a current equal to, or greater, than the threshold current I*, are carried out consequently to the step of decreasing the power supply current of at least a part of said current adjustment modules 2 of the sources of the first group G1, down to a predetermined threshold current value I*, and in which said third overall brightness level L2 is lower than the second brightness level L1.

According to one aspect, the step of turning off a second group G2 of light sources SL, having a second number n2 of sources, with said second group G2 of light sources SL defined by a part of the light sources SL of the first group G1 comprises a step of progressively turning off an increasing number of light sources (preferably until reaching a substantially zero overall brightness).

In this way it is possible to create a transition to low brightness levels, up to the total absence of light, without causing shadows or chromatic deviations in the light emitted by the light sources SL (it should be noted that the light sources kept turned on are kept powered at a current higher than the threshold I*).

FIG. 3 shows (in the graph at the top) the current of a light source forming part of the first group and the third group, that is, kept turned on, with respect to the time in which the method of adjustment is performed.

As can be understood, the power supply current of this source SL is decreased to the threshold value I*, after which it is kept constant (at that point, to have the effect of decreasing brightness, some light sources SL are turned off).

FIG. 3 also shows (in the graph at the bottom) the trend of the overall brightness emitted by the projector 1 with respect to the time in which the method od adjustment is performed.

According to another aspect, the current generator module 2 is configured to generate a pulse width modulation type current.

According to another aspect, the method comprises a step of increasing the brightness of said light sources SL (preferably turning on), comprising the following steps, carried out by the control unit 3:
progressively increasing the number of light sources SL which are on, by progressively turning on light sources SL and feeding them with a current value equal to or greater than the predetermined threshold current value I*;
when all the light sources SL have been turned on, and fed with a current value equal to or greater than the predetermined threshold current value I*, performing the following actions:
increasing the power supply current of at least a part of the light sources SL of the first group G1, to further increase the brightness level.

Basically, during the turning on, the light sources SL are turned on one after the other (also in groups) and immediately fed with the threshold current I*.

It should be noted that this step of increasing the brightness, if relative to the turning on, is carried out starting from a level of power supply current of the SL sources of the first group G1 which is substantially zero, or in any case lower than the threshold current value I*.

Once all the light sources SL have been fed at the threshold current I*, according to the method, the power supply current of the light sources SL is increased, so as to further increase the brightness.

In essence, during an initial step of increasing the brightness, the increase in brightness is determined by an increase in the light sources SL turned on and fed at the threshold current I*.

On the other hand, in a second step of increasing in brightness, the increase in brightness is determined by an increase in the power supply current of the light sources SL.

According to one aspect, each light source SL comprises a group of LEDs configured to emit light of different colours.

Preferably, each light source SL comprises a group of LEDs configured to emit light of different colours according to the RGB (red, green, blue) standard.

Alternatively, each light source SL comprises a group of LEDs configured to emit light of different colours according to the RGBLAC (red, green, blue, lime, amber, cyan) or RGBLACW (red, green, blue, lime, amber, cyan, white) or RGBWA or RGBA, RGBL, RGBW1W2 standard.

It should be noted that, according to this aspect, the white light is obtained by appropriately mixing the light of the coloured LEDs with a different percentage of contribution from each of them (with control of each coloured LED independently) based on the colour temperature of the white to be obtained.

Advantageously, according to this aspect, the fact of turning off some sources below a predetermined threshold current I* means that there is no chromatic drift of light even at low overall brightnesses levels.

In fact, the relationship/proportion between the emitted light of the coloured LEDs and their power supply current is not always the same, which, according to the prior art systems, implies, for example, that under a certain threshold the resulting emitted light changes and may also tend to be, for example, reddish or greenish instead of white.

According to yet another aspect, said first group G1 of light sources SL comprises arrays of LEDS each composed of light sources SL configured to emit light of different colours, comprising a step, carried out by means of the control unit 3, of:
setting (for example by means of reading a value stored in a memory, not illustrated), as a function of a set lighting colour, power supply current values associated with each light source SL of an LED array;
feeding each light source SL of an array of LEDs with the power supply current values set.

It should be noted that the colour emitted by an array of LEDs depends on the brightness emitted by each source SL of different colour.

It has been experimentally found that as the current decreases, SL sources (LEDs) of different colours (that is having emission centred on different wavelengths) have a different light emission curve (curve L-I).

Advantageously, the fact that, within an array of LEDs, each light source SL is fed with a predetermined current (even different from that of the sources Sl of the same array), means that any chromatic drift is avoided.

This is particularly important in the case where, for example, white light is created by superimposing lights of different colours; in this case a chromatic drift of the light emitted when the current decreases would in fact be quite evident for people positioned near the lighting system.

In essence, advantageously, the proposed method for adjusting the brightness overcomes the disadvantages of chromatic drift, defining in all respects an anti-chromatic drift functionality (as the current decreases) in the case of arrays of LEDs with light sources of different colours.

In fact, the power supply current associated with each light source SL of an array of LEDs can be suitably set, according to the colour, to avoid chromatic drift.

In particular, even at the current threshold I* can be different, for each source SL (LEDs) of different colour (that is having emission centred on different wavelengths).

More precisely, according to this aspect of the method, since the response curve (light emissivity) of each light source can be modified as the power supply current decreases, it is envisaged to set, according to a stored profile, the power supply value current of each light emission source SL (of different colour), so as to be able to maintain the same colour even in the face of a decrease in the power supply current of the array of LEDs.

In essence, furthermore, according to the method, it is envisaged to associate each light emission source SL with a threshold current value I* (that is, minimum current) specific to the source itself.

According to another aspect (clearly illustrated in FIGS. 5-9), the step of decreasing the power supply current of at least a part (preferably of each) of said current adjustment modules 2 of the sources of the first group G1, down to a predetermined threshold current value I* comprises a step of decreasing the power supply current according to at least one of the following relationships between the power supply current and the brightness emitted by the single light source SL:
a linear relation R1;
an S-type relation R2;
an exponential relation R3;
a reverse exponential relation R4;
a relation R5 having a first slope P1, with low power supply currents, a second intermediate slope P2, with intermediate power supply currents, and a third slope P3 for high power supply currents.

It should be noted that, for the relation R5, the first slope P1 and the third slope P3 are higher than the intermediate slope P2.

1. A method for adjusting the brightness of a plurality of light sources of the LED type arranged to form a first group having a first number of sources, the method comprising the following steps:
providing a control unit;
providing a plurality of current adjustment modules, each associated with a respective light source and connected to said control unit, to be controlled by it, and to one of said light sources to feed it with power supply current; the method also comprising the following steps, carried out by the control unit:
turning on the light sources of the first group to emit light at a first overall brightness and controlling the current adjustment modules of the first group with a first current;
decreasing the power supply current of at least a part of said current adjustment modules of the sources of the first group, down to a predetermined threshold current value, which corresponds to a second predetermined overall brightness level, lower than the first overall brightness:
turning off a second group of light sources, having a second number of sources, with said second group of light sources defined by a part of the light sources of the first group;
continuing to feed the remaining sources of the first group, defining a third group of light sources having a third number of sources and different from the second group, fed with a current equal to or greater than the threshold current;
and wherein said steps of turning off a second group of light sources and continuing to feed the remaining sources of the first group with a current equal to or greater than the threshold current allow light to be emitted at a third overall brightness level different from the second brightness level.

2. The method according to claim 1, wherein the steps of turning off a second group of light sources and keeping the remaining sources of the first group, defining a third group of light sources having a third number of sources and different from the second group, fed with a current equal to or greater than the threshold current are carried out consequently to the step of decreasing the power supply current of at least a part of said current adjustment modules of the sources of the first group, down to a predetermined threshold current value, and wherein said third overall brightness level is lower than the second brightness level.

3. The method according to claim 1, wherein the following are carried out simultaneously:
the step of decreasing the power supply current of at least a part of said current adjustment modules of the sources of the first group
and the step of turning off a second group of light sources, having a second number of sources, with said second group of light sources defined by a part of the light sources of the first group.

4. The method according to claim 1, wherein the step of turning off a second group of light sources, having a second number of sources, with said second group of light sources defined by a part of the light sources of the first group, is performed before the step of decreasing the power supply current of at least a part of said current adjustment modules of the sources of the first group.

5. The method according to claim 1, wherein each light source comprises a group of LEDs configured to emit light of different colours.

6. The method according to claim 1, wherein each light source comprises a group of LEDs configured to emit, between them, light of different colours, according to the RGB standard.

7. The method according to claim 1, wherein each light source comprises a group of LEDs configured to emit light of different colours according to the RGBLAC or RGBLACW or RGBWA or RGBA, RGBL, RGBW1W2 standard.

8. The method according to claim 1, wherein the step of turning off a second group of light sources, having a second number of sources, with said second group of light sources defined by a part of the light sources of the first group comprises a step of progressively turning off an increasing number of light sources.

9. The method according to claim 1, wherein the step of turning off a second group of light sources, having a second number of sources, with said second group of light sources defined by a part of the light sources of the first group comprises a step of progressively turning off an increasing number of light sources, until reaching a substantially zero brightness level.

10. The method according to claim 1, wherein a step of increasing the brightness of said light sources, comprising the following steps, carried out by the control unit:
progressively increasing the number of light sources which are on, by progressively turning on light sources and feeding them with a current value equal to or greater than the predetermined threshold current value;
when all the light sources are on, and fed with a current value equal to or greater than the predetermined threshold current value, performing the following actions:
increasing the power supply current of at least a part of the light sources of the first group, to further increase the brightness level.

11. The method according to claim 1, wherein said first group of light sources comprises arrays of LEDs each composed of a plurality of light sources configured to emit light of different colours, comprising a step, carried out by the control unit, of:
setting, depending on a set lighting colour, power supply current values associated with each illumination source of an array of LEDs;
feeding each light source of an array of LEDs with the respective power supply current value set.

12. The method according to claim 1, wherein the step of decreasing the power supply current of at least a part of said current adjustment modules of the sources of the first group, down to a predetermined threshold current value, comprises a step of decreasing the power supply current according to at least one of the following relations between the power supply current and the brightness emitted by the single light source:
a linear relation;
an S-type relation;
an exponential relation;
a reverse exponential relation;
a relation having a first slope, with low power supply currents, a second intermediate slope, with intermediate power supply currents, and a third slope for high power supply currents.

13. A system for projecting light beams, comprising:
a plurality of light sources of the LED type arranged to form a first group of light sources;
a control unit;
a plurality of current adjustment modules, connected to said control unit, to be controlled by it, each of them being associated with a light source to feed it with power supply current,
the control unit being configured to carry out the following operations:
turning on the light sources of the first group to emit light according to a first brightness and controlling the current adjustment modules of the first group for providing a first power supply current;
decreasing the power supply current of at least a part of said current adjustment modules of the sources of the first group, down to a predetermined threshold current value, which corresponds to a second predetermined overall brightness level, lower than the first overall brightness, and consequently carrying out the following steps:
turning off a second group of light sources, having a second number of sources, with said second group of light sources defined by a part of the light sources of the first group
continuing to feed the remaining sources of the first group, defining a third group of light sources having a third number of sources and different from the second group, fed with a current equal to or greater than the threshold current;
and wherein said steps of turning off a second group of light sources and continuing to feed the remaining sources of the first group with a current equal to or greater than the threshold current allow light to be emitted at a third brightness level different from the second brightness level.

14. The system according to claim 13, wherein the control unit is configured to simultaneously perform the following operations:
decreasing the power supply current of at least a part of said current adjustment modules of the sources of the first group;
turning off a second group of light sources, having a second number of sources, with said second group of light sources defined by a part of the light sources of the first group.

15. The system according to claim 13, wherein the control unit is configured for turning off a second group of light sources, having a second number of sources, with said second group of light sources defined by a part of the light sources of the first group, before decreasing the power supply current of at least a part of said current adjustment modules of the sources of the first group.

16. The system according to claim 13, comprising:
a user interface, connected to the control unit and configured for:
receiving data concerning a desired level of lighting of said light sources equal to the predetermined threshold current value;
providing a display of settings of said lighting level.

17. The system according to claim 13, comprising a user interface, connected to the control unit and configured to allow selection of a dimming curve that expresses a relation between the brightness emitted by each source and the power supply current.

18. The system according to claim 13, wherein the user interface is configured to allow selection of a dimming curve expressing a relation between the brightness emitted by each source and the power supply current at least between:
a linear relation;
an S-type relation;
an exponential relation;
a reverse exponential relation;
a relation having a first slope, with low power supply currents, a second intermediate slope, with intermediate power supply currents, and a third slope for high power supply currents.

19. The system according to claim 13, wherein the control unit is configured to individually turn on/off each light source.

20. The system according to claim 13, wherein the control unit is configured to control each current adjustment module and adjust, individually, the power supply current of each light source.

21. The system according to claim 13, wherein at least said first group of light sources comprises arrays of LEDs each composed of a plurality of light sources configured to emit light of different colours, and wherein the control unit is configured for:
setting, depending on a set lighting colour, power supply current values associated with each light source;
feeding each light source with the respective set power supply current value;
controlling each current adjustment module and adjusting, individually, the power supply current of each light source of the array of LEDs, to the respective set power supply current value.

22. The system according to claim 13, wherein the third brightness level is lower than the second brightness level.
